(19) United States
(12) Patent Application Publication
(10) Pub. No.: US 2012/0105325 A1
(43) Pub. Date: May 3, 2012

(54) CAPACITIVE FINGER NAVIGATION INPUT DEVICE

(75) Inventors: Michael J. Brosnan, Fremont, CA (US); Thomas P. Murphy, Boulder Creek, CA (US)

(73) Assignee: AVAGO TECHNOLOGIES ECBU IP (SINGAPORE) PTE. LTD., Singapore (SG)

(21) Appl. No.: 12/913,195

(22) Filed: Oct. 27, 2010

(51) Int. Cl. G06F 3/033

(52) U.S. Cl. 345/158

(57) ABSTRACT

A capacitive finger navigation input device uses a capacitive sensor array of capacitive sensing cells that includes only two capacitive sensing cells positioned along a linear direction. The capacitive finger navigation input device uses a drive circuit to drive at least one drive electrode of the capacitive sensor array and a sense circuit to sense mutual capacitance at each of the capacitive sensing cells of the capacitive sensor array to produce mutual capacitance signals, which are used to determine at least one of position and movement of a finger of a user with respect to the capacitive sensor array. The capacitive finger navigation input device may be used in a hand-held computing device and in a method for performing finger navigation.

### BACKGROUND

Conventional input devices, such as computer mice and touchpads, were developed to be used with relatively large computing devices. For example, the computer mice were developed to be used with desktop computers and the touchpads were developed to be used on notebook computers. Thus, these conventional input devices are not practical for use with small hand-held mobile devices, such as personal digital assistants, GPS devices, cellular phones and smart phones. For hand-held mobile device, different input solutions have been developed to accommodate the size and configuration of these devices.

A popular input solution for use in small hand-held mobile devices is the touchscreen. Since most hand-held mobile devices include screens, the use of touchscreens in these mobile devices does not require additional space on these small compact devices. Furthermore, touchscreens are intuitive and user friendly since users are able to physically “touch” to activate or move graphically displayed elements.

However, even for mobile device with touchscreens, there is a need for more precise and rapid mouse-like navigation for fine positioning of a cursor, a highlighted character in text entry (e.g., for insertion or deletion in the middle of a word), a highlighted item in a long list or a small target on a web page or menu display. Thus, optical finger navigation input devices have been incorporated into mobile devices, such as mobile phones, to supplement touchscreens. Optical finger navigation input devices use a light source and an image sensor array with one or more optical elements to illuminate a user's finger and generate digital images from light that is reflected off of the user's finger. Successive digital images are compared to each other to compute movement information. Typical optical finger navigation systems output two-dimensional movement information that represents the two-dimensional movement of the finger relative to the sensor array. The two-dimensional movement information is then used to move a cursor or highlight position on the display of a corresponding computing device.

A weakness of the optical finger navigation input devices is that these devices are not thin enough for some applications. As an example, certain mobile phone designs require the input device to be very thin (e.g., less than 2 mm thick) in order to fit in a thin sliding keyboard mechanism or thin display/keypad region.

Thus, although optical finger navigation input devices work well for their intended purpose, there is a need for a finger navigation input device with thin profile so that the finger navigation input device can fit in more mobile device designs.

### SUMMARY

A capacitive finger navigation input device uses a capacitive sensor array of capacitive sensing cells that includes only two capacitive sensing cells positioned along a linear direction. The capacitive finger navigation input device uses a drive circuit to drive at least one drive electrode of the capacitive sensor array and a sense circuit to sense mutual capacitance at each of the capacitive sensing cells of the capacitive sensor array to produce mutual capacitance signals, which are used to determine at least one of position and movement of a finger of a user with respect to the capacitive sensor array. The capacitive finger navigation input device may be used in a hand-held computing device and in a method for performing finger navigation.

A capacitive finger navigation input device in accordance with an embodiment of the invention comprises a capacitive sensor array of capacitive sensing cells, a drive circuit, a sensing circuit and a navigation engine. The capacitive sensor array includes only two capacitive sensing cells positioned along a linear direction. The capacitive sensor array includes a substrate, at least one drive electrode positioned over the substrate, at least one sense electrode positioned over the substrate and electrically separated from the at least one drive electrode, where at least a portion of the at least one drive electrode and at least a portion of the at least one sense electrode define each of the capacitive sensing cells, and an insulating cover layer positioned over the drive and sense electrodes, the insulating cover layer being positioned to interface with a finger of a user. The drive circuit is electrically connected to the drive electrode to supply a drive signal to the drive electrode. The sensing circuit is electrically connected to the sense electrode to sense mutual capacitance at each of the capacitive sensing cells to produce mutual capacitance signals. The navigation engine is connected to the sensing circuit to receive the mutual capacitance signals. The navigation engine is configured to process the mutual capacitance signals for the capacitive sensing cells of the capacitive sensor array to determine at least one of position and movement of a finger of a user with respect to the capacitive sensor array.

A hand-held computing system in accordance with an embodiment of the invention comprises a display device, a capacitive sensor array, a drive circuit, a sense circuit and a navigation device. The display device comprises a navigation indicator for a graphical user interface. The capacitive sensor array includes only two capacitive sensing cells positioned along a linear direction. The capacitive sensor array includes a substrate, at least one drive electrode positioned over the substrate, at least one sense electrode positioned over the substrate and electrically separated from the at least one drive electrode, where at least a portion of the at least one drive electrode and at least a portion of the at least one sense electrode define each of the capacitive sensing cells, and an insulating cover layer positioned over the drive and sense electrodes, the insulating cover layer being positioned to interface with a finger of a user. The drive circuit is electrically connected to the drive electrode to supply a drive signal to the drive electrode. The sensing circuit is electrically connected to the sense electrode to sense mutual capacitance at each of the capacitive sensing cells to produce mutual capacitance signals. The navigation engine is connected to the sensing circuit to receive the mutual capacitance signals. The navigation engine is configured to process the mutual capacitance signals for the capacitive sensing cells of the capacitive sensor array to determine at least one of position and movement of a finger of a user with respect to the capacitive sensor array to control the navigation indicator.

A method for performing capacitive finger navigation in accordance with an embodiment of the invention comprises providing a driving signal to at least one drive electrode of a capacitive sensor array of capacitive sensing cells, the capacitive sensor array including only two capacitive sensing cells positioned along a linear direction, sensing mutual capacitances at the capacitive sensing cells of the capacitive sensor array through at least one sense electrode of the capacitive sensor array to produce mutual capacitance signals, and processing the mutual capacitance signals for the capacitive sensing cells of the capacitive sensor array to determine at least one of position and movement of a finger of a user with respect to the capacitive sensor array.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 shows a hand-held computing device that includes a capacitive finger navigation input device as a user input device in accordance with an embodiment of the invention.

FIG. 2 is a functional block diagram of an embodiment of the capacitive finger navigation input device in accordance with an embodiment of the invention.

FIG. 3 illustrates drive and sense electrodes of a capacitive sensor array of the capacitive finger navigation input device in accordance with an embodiment of the invention.

FIG. 4 illustrates a sensing unit of a sensing circuit of the capacitive finger navigation input device in accordance with an embodiment of the invention.

FIGS. 5A, 5B, 5C and 5D depict block diagrams illustrating different configurations of the sense electrodes of the capacitive sensor array of the capacitive finger navigation input device.

FIG. 6 illustrates drive and sense electrodes of a capacitive sensor array of the capacitive finger navigation input device in accordance with alternative embodiment of the invention.

FIG. 7 is a block diagram of a round capacitive sensor array in accordance with an embodiment of the invention.

FIG. 8 is a process flow diagram of a method for performing finger navigation in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

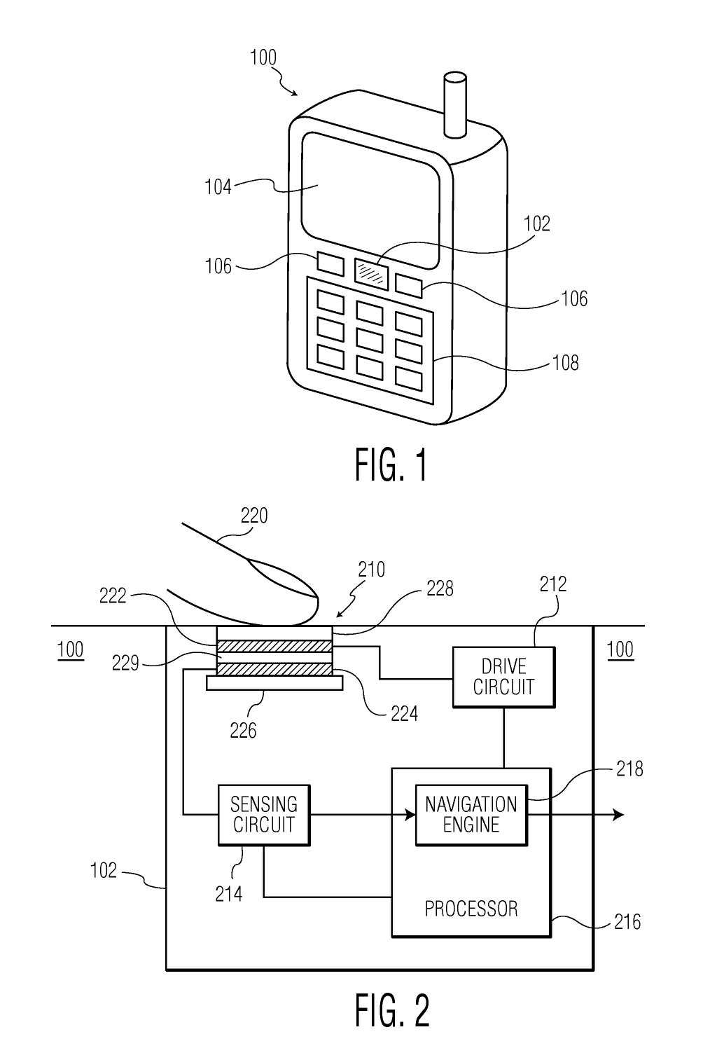

In FIG. 1, a hand-held computing device 100 that includes a capacitive finger navigation input device 102 as a user input device in accordance with an embodiment of the invention is shown. The capacitive finger navigation input device and corresponding capacitive finger navigation techniques are described in more detail below. The hand-held computing device also includes a display device 104, function keys 106, and an alphanumeric keypad 108. The hand-held computing device provides a graphical user interface on the display device and the capacitive finger navigation input device is used to navigate within the graphical user interface. In some embodiments, the display device of the hand-held computing device may be a touchscreen and the capacitive finger navigation input device is separate and not part of the touchscreen. As an example, the display device may a capacitive touchscreen. In these embodiments, the capacitive finger navigation input device may be used as a supplemental input device or an alternative input device with respect to the touchscreen of the hand-held computing device. In FIG. 1, the hand-held computing device is illustrated as a cellular phone as an example of a computing device that could utilize the capacitive finger navigation input device. However, the capacitive finger navigation input device can be used in other types of computing devices, such as laptop computers, desktop computers, smart phones, global positioning system (GPS) devices, personal music players, and PDAs.

The capacitive finger navigation input device 102 facilitates user input to navigate within content displayed on the display device 104 of the hand-held computing device 100. For example, the capacitive finger navigation input device facilitates control of a navigation indicator within a graphical user interface that is displayed on the display device. The navigation indicator may be a cursor, a highlighter, an arrow, or another type of navigation indicator. Additionally, the user input received through the capacitive finger navigation input device may facilitate other types of user-controlled functionality including, but not limited to, volume controls, audio playback selections, browser controls, and so forth. The type of user-controlled functionality that may be implemented with embodiments of the capacitive finger navigation input device depends on the type of functionality generally provided by the hand-held computing device. Also, although FIG. 1 specifically illustrates a hand-held computing device, the capacitive finger navigation input device may be used in electronic devices which are portable, but not necessarily held in a user's hand, or devices which are generally considered to be not portable.

Turning now to FIG. 2, a functional block diagram of an embodiment of the capacitive finger navigation input device 102 is shown. The capacitive finger navigation input device includes a capacitive sensor array 210, a drive circuit 212, a sensing circuit 214 and a processor 216 with a navigation engine 218. The capacitive sensor array is configured to collect mutual capacitive information related to a finger 220 placed on or very close to the capacitive sensor array. The collected mutual capacitive information is then used to estimate the position or motion of the finger relative to the capacitive sensory array in order to output control signals in response to the position or movement of the user's finger. The output control signals are used to control a navigation indicator within a graphical user interface that is displayed on the display device 104 of the hand-held computing device 100. It is noted here that the capacitive finger navigation input device will also work with a conductive object or a capacitance-influencing object other than the user's finger.

As illustrated in FIG. 2, the capacitive sensor array 210 of the capacitive finger navigation input device 102 includes a drive electrode layer 222 and a sense electrode layer 224 positioned between a substrate 226 and a cover layer 228. The substrate can be made of any material, which may be insulating or semiconductive, to support the drive and sense electrode layers. In addition, the substrate may be made of rigid or flexible material. The cover layer is made of an insulating material. As an example, the cover layer may be made of a plastic material. The cover layer is used as an interface for the finger 220 of the user. As shown in FIG. 2, the cover layer is the layer that the finger contacts for the user to use the capacitance finger navigation input device. However, in some embodiments, the finger may not have to actually contact the cover layer for the user to use the capacitance finger navigation input device.

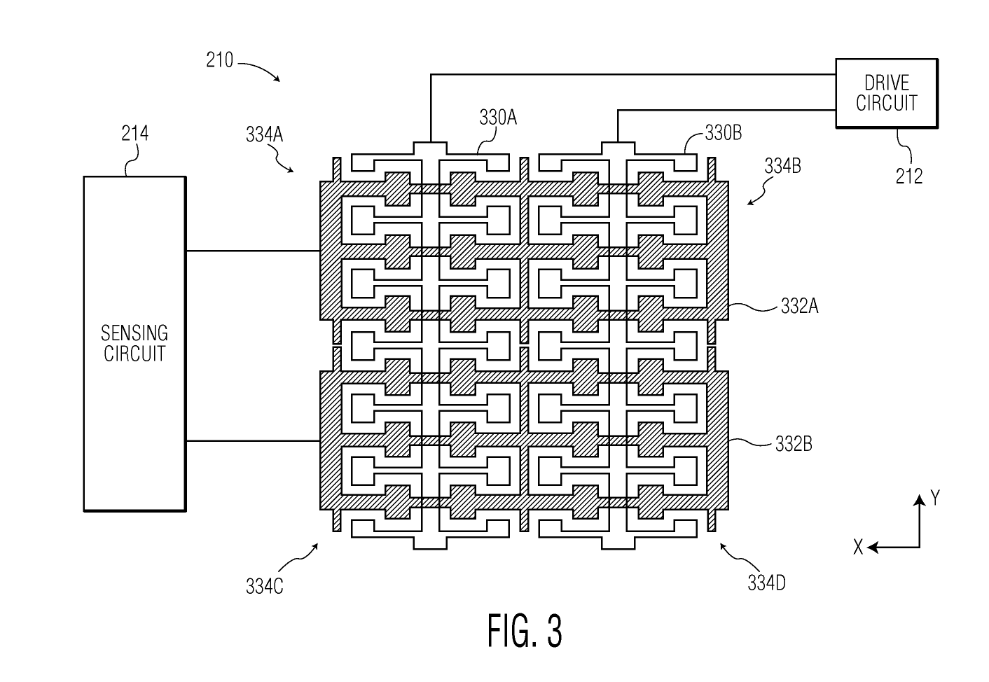

The drive electrode layer 222 of the capacitive sensor array 210 includes drive electrodes 330A and 330B, which are shown in FIG. 3 in accordance with one embodiment. Similarly, the sense electrode layer 224 includes sense electrodes 332A and 332B, which are also shown in FIG. 3 in accordance with one embodiment. The drive and sense electrodes of the capacitive sensor array are described below with respect to FIG. 3. In the embodiment shown in FIG. 2, the drive and sense electrode layers are spatially separated by an insulating intermediate layer 229. Thus, drive electrodes of the drive electrode layer are positioned at one level of the capacitive sensor array, while the sense electrodes of the sense electrode layer are positioned at another level of the capacitive sensor array. Although the drive electrode layer is shown to be positioned at a higher level of the capacitive sensor array than the sense electrode layer, i.e., more distant from the substrate 226, the relative positions of the drive and sense electrode layers with respect to the substrate may be reversed. In other embodiments, the drive and sense electrode layers may be integrated into a single layer, where any overlapping regions or sections of the drive and sense electrodes are separated by insulating material so that there is no electrical contact between the drive and sense electrodes.

Turning now to FIG. 3, the drive and sense electrodes 330A, 330B, 332A and 332B of the capacitive sensor array 210 in accordance with an embodiment of the invention are illustrated. FIG. 3 is a top view of the capacitive sensor array with only the drive and sense electrodes shown. In this embodiment, the capacitive sensor array includes two drive electrodes, which are electrically separated from each other. As shown in FIG. 3, the drive electrode 330A includes conductive traces that are distributed in the left half of the capacitive sensor array, while the drive electrode 330B include conductive traces that are distributed in the right half of the capacitive sensor array. The capacitive sensor array also includes two sense electrodes, which are electrically separated from each other. The sense electrode 332A includes conductive traces that are distributed in the upper half of the capacitive sensor array, while the sense electrode 332B includes conductive traces that are distributed in the lower half of the capacitive sensor array. The drive and sense electrodes may be made any conductive material. As an example, the drive and sense electrodes may be made of copper (Cu) or Indium Tin Oxide (ITO).

As shown in FIG. 3, the relative positions of the drive and sense electrodes 330A, 330B, 332A and 332B define four regions or quadrants of the capacitive sensor array 210. The portions of the drive and sense electrodes that occupy the same regions of the capacitive sensor array form capacitive sensing cells 334A, 334B, 334C and 334D of the capacitive sensor array. Thus, the drive and sense electrodes form the four capacitive sensing cells of the capacitive sensor array, where each of the four capacitive sensing cells is located at one of the quadrants of the capacitive sensor array. The upper half portion of the drive electrode 330A and the left half portion of the sense electrode 332A define the capacitive sensing cell 334A at the upper left quadrant of the capacitive sensor array. The upper half portion of the drive electrode 330A and the right half portion of the sense electrode 332A define the capacitive sensing cell 334B at the upper right quadrant of the capacitive sensor array. The lower half portion of the drive electrode 330B and the left half portion of the sense electrode 332B define the capacitive sensing cell 334C at the lower left quadrant of the capacitive sensor array. The lower half portion of the drive electrode 330B and the right half portion of the sense electrode 332B define the capacitive sensing cell 334D at the lower right quadrant of the capacitive sensor array. Thus, the capacitive sensory array has only two capacitive sensing cells along any linear direction, i.e., along a straight line. The capacitive sensory array has the two linear capacitive sensing cells 334A and 334B or the two linear capacitive sensing cells 334C and 334D along the X axis, as indicated in FIG. 3. Similarly, the capacitive sensory array has the two linear capacitive sensing cells 334A and 334C or the two linear capacitive sensing cells 334B and 334D along the Y axis, as indicated in FIG. 3.

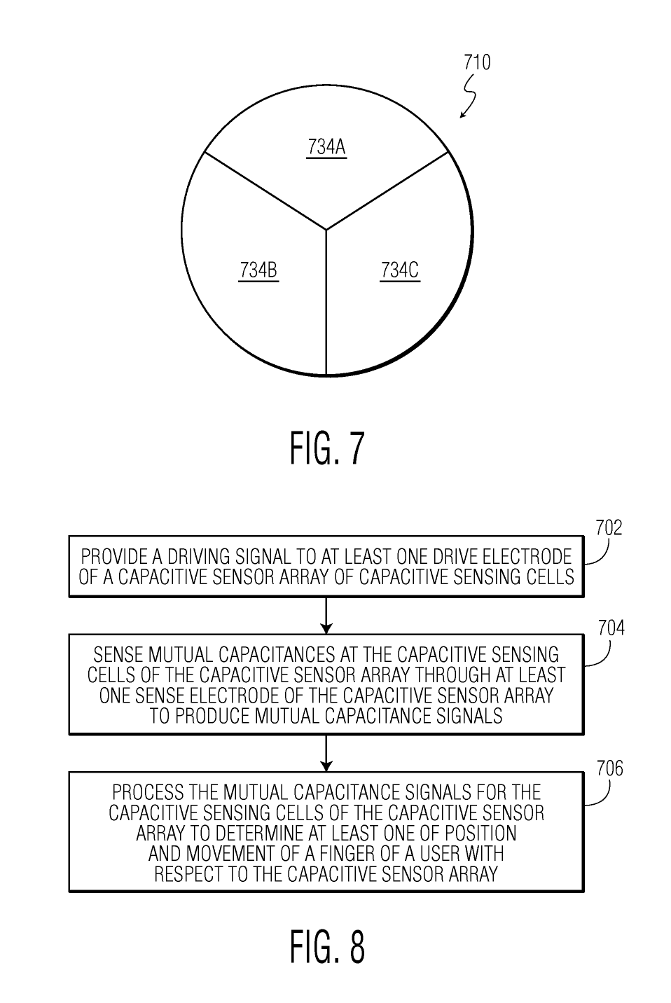

The capacitive sensor array 210 is designed to accommodate a finger of a user to control the capacitive finger navigation input device 102. Thus, the capacitive sensor array cannot be too small or too large to sense the position or motion of the finger relative to the capacitive sensor array in order to properly determine the position or movement of the finger. In an embodiment, the capacitive sensor array is quadrilateral in shape with width of 4 mm to 20 mm and height of 4 mm to 20 mm. As an example, the capacitive sensor array is square in shape with width of 10 mm and height of 10 mm. In this example, each of the capacitive sensing cells 334A, 334B, 334C and 334D is a 5 mm by 5 mm square. Although the capacitive sensor array is illustrated as being quadrilateral in shape, the capacitive sensor array may be configured in a different shape, such as a circle, oval or polygon, in other embodiments. In an alternative embodiment, the capacitive sensor array may be round in shape with each of the capacitive sensing cells of the circular capacitive sensor array being configured in a pie segment shape, as described below with reference to FIG. 7.

Turning back to FIG. 2, the drive circuit 212 of the capacitive finger navigation input device 102 is connected to the drive electrode layer 222. More specifically, the drive circuit is connected to the drive electrodes 330A and 330B of the drive electrode layer, as illustrated in FIG. 3. The drive circuit is configured to sequentially provide a drive signal to the drive electrodes. As an example, the drive circuit may be configured to sequentially provide a drive waveform, such as a 125 KHz square wave. In the embodiment illustrated in FIG. 3, the drive circuit uses two drive lines to sequentially provide the drive signal to each of the two drive electrodes. However, as explained below, in other embodiments, the drive circuit may use different number of drive lines.

The sensing circuit 214 of the capacitive finger navigation input device 102 is connected to the sense electrode layer 224. More specifically, the sensing circuit is connected to the sense electrodes 332a and 332B of the sense electrode layer, as illustrated in FIG. 3. The sensing circuit is configured to sense or measure the mutual capacitance between the portion of the drive electrode 330A or 330B that is currently receiving the drive signal from the drive circuit 212 and the overlapping or associated portion of the sense electrode 332A or 332B that is being sensed by the sensing circuit. Thus, the sensing circuit can sense the mutual capacitance from each of the four capacitive sensing cells 334A, 334B, 334C and 334D of the capacitive sensor array 210, which is altered in the presence of a capacitance-influencing object, e.g., the finger 220. Consequently, the position of the finger relative to the capacitive sensing cells of the capacitive sensor array can be determined by measuring the mutual capacitance from each of the capacitive sensing cells. The sensing circuit generates output value signals that are indicative of the mutual capacitances from the four capacitive sensing cells of the capacitive sensor array.

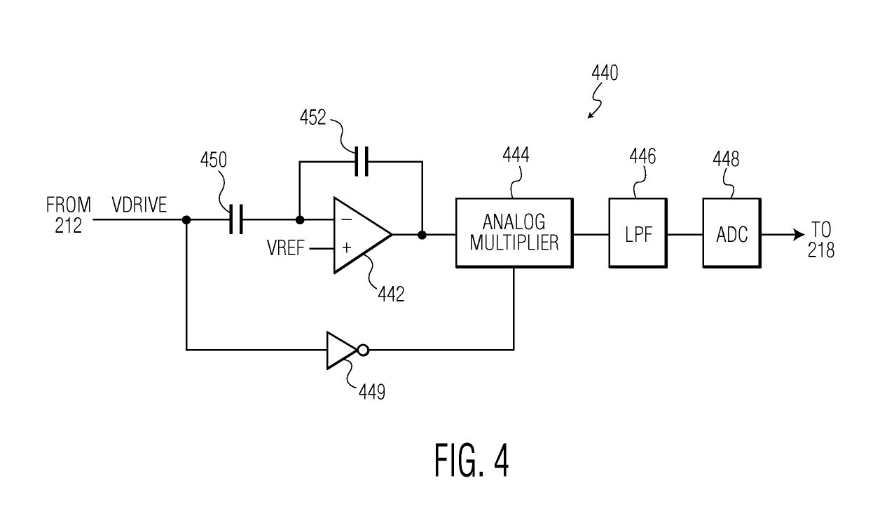

In a particular implementation, the sensing circuit 214 utilizes a sensing unit 440 for each of the sense electrodes 332A and 332B in accordance with an embodiment, as shown in FIG. 4. The sensing unit includes a charge amplifier 442, an analog multiplier 444, a low pass filter 446 and an analog-to-digital converter (ADC) 448. In FIG. 4, a capacitor 450 is shown to be attached to the negative input of the charge amplifier. The capacitor represents the mutual capacitance at one of the capacitive sensing cells 334A, 334B, 334C and 334D, i.e., the mutual capacitance of the drive electrode 330A or 330B that is being driven by a drive signal VDRIVE and the sense electrode 332A or 332B that is being sensed by the sensing unit. As shown in FIG. 4, a reference voltage VREF is applied to the positive input of the charge amplifier, which has a negative feedback with a feedback capacitor 452. The charge amplifier functions as a charge to voltage converter to provide a voltage measurement of the charge induced through the feedback capacitor, which provide a measurement of the mutual capacitance at the capacitive sensing cell being measured by the sensing unit. The output of the charge amplifier is connected to the analog multiplier, which multiplies the output signal of the charge amplifier with the drive signal VDRIVE inverted by an inverter 449. The output of the analog multiplier is connected to the low pass filter. The analog multiplier and the low pass filter perform synchronous demodulation. The output of the synchronous demodulation is fed to the ADC, which converts the resulting signal from an analog signal to a digital signal, which is transmitted to the navigation engine 218 of the processor 216 for processing.

Since the capacitive sensor array 210 shown in FIG. 3 has a configuration of two drive electrodes and two sense electrodes, the sensing circuit 214 of the capacitive finger navigation input device 102 utilizes two sensing units, which can each be the sensing unit illustrated in FIG. 4. However, in other configurations, the sensing circuit of the capacitive finger navigation input device may utilize one or four sensing units, as described below.

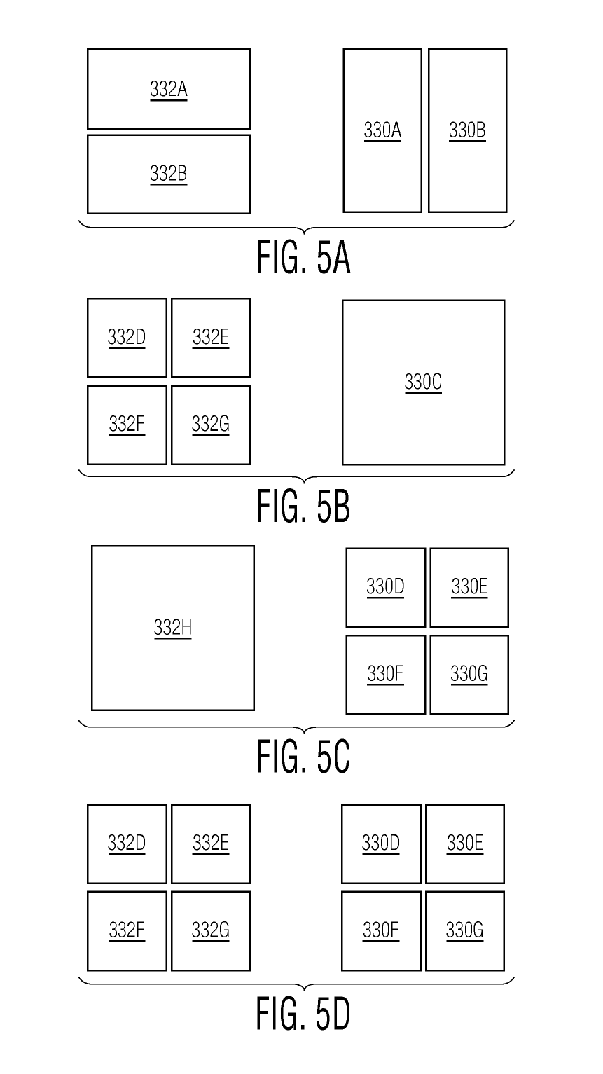

The configuration of the capacitive sensor array 210 shown in FIG. 3 can be illustrated in a block diagram form, as shown in FIG. 5A. In FIG. 5A, the drive electrodes 330A and 330B and the sense electrodes 332A and 332B are shown side by side. The drive electrodes are illustrated as two rectangles that are orientated so that their longer sides are vertical, while the sense electrodes are illustrated as two rectangles that are orientated so that their longer sides are horizontal. In this configuration, two separate drive lines connected to the two drive electrodes are needed to sequentially drive the drive electrodes and two sensing units connected to the two sense electrodes are needed to sense the mutual capacitances from each of the four capacitive sensing cells 334A, 334B, 334C and 334D.

An alternative configuration of the capacitive sensor array 210 is shown in FIG. 5B. In this configuration, the capacitive sensor array includes one drive electrode 330C and four sense electrodes 332D, 332E, 332F and 332G. In FIG. 5B, the drive electrode is illustrated as a single large square that occupies all four capacitive sensing cells 334A, 334B, 334C and 334D of the capacitive sensor array, while the four sense electrodes are illustrated as four squares that correspond to the four capacitive sensing cells of the capacitive sensor array. In this configuration, only one drive line connected to the drive electrode is needed to drive the drive electrode and four sensing units connected to the four sense electrodes are needed to sense the mutual capacitances from each of the four capacitive sensing cells.

Another alternative configuration of the capacitive sensor array 210 is shown in FIG. 5C. In this configuration, the capacitive sensor array includes four drive electrodes 330D, 330E, 330F and 330G and one sense electrode 332H. In FIG. 5C, the sense electrode is illustrated as a single large square that occupies all four capacitive sensing cells 334A, 334B, 334C and 334D of the capacitive sensor array, while the four drive electrodes are illustrated as four squares that correspond to the four capacitive sensing cells of the capacitive sensor array. In this configuration, four drive lines connected to the four drive electrodes are needed to sequentially drive the four drive electrodes and only one sensing unit connected to the sense electrode is needed to sense the mutual capacitances from each of the four capacitive sensing cells.

Still another alternative configuration of the capacitive sensor array is shown in FIG. 5D. In this configuration, the capacitive sensor array includes the four drive electrodes 330D, 330E, 330F and 330G and four sense electrodes 332D, 332E, 332F and 332G. In FIG. 5D, the four drive electrodes are illustrated as four squares that correspond to the four capacitive sensing cells 334A, 334B, 334C and 334D of the capacitive sensor array. Similarly, the four drive electrodes are illustrated as four squares that also correspond to the four capacitive sensing cells of the capacitive sensor array. In this configuration, four drive lines connected to the four drive electrodes can be used to sequentially or simultaneously drive the four drive electrodes and four sensing units connected to the four sense electrodes can be used to sense the mutual capacitances from each of the four capacitive sensing cells. However, similar to the configuration of FIG. 5A, two drive lines connected to pairs of drive electrodes can be used to sequentially drive the pairs of drive electrodes and two sensing units connected to pairs of sense electrodes can be used to sense the mutual capacitances from each of the four capacitive sensing cells. Alternatively, similar to the configuration of FIG. 5B, four drive lines connected to the four drive electrodes can be used to individually drive the four drive electrodes and one sensing unit connected to the four sense electrodes can be used to sense the mutual capacitances from each of the four capacitive sensing cells. Also, similar to the configuration of FIG. 5C, one drive line connected to the four drive electrodes can be used to drive all four drive electrodes and four sensing units connected to the four sense electrodes can be used to sense the mutual capacitances from each of the four capacitive sensing cells.

Although not illustrated, it is also possible to configure the capacitive sensor array 210 so that the capacitive sensor array has two drive electrodes and four sense electrodes or has four drive electrodes and two sense electrodes. Thus, in these configurations, the capacitive sensor array may use one, two or four drive lines to drive the drive electrodes and use one, two or four sensing units to sense the mutual capacitances from each of the four capacitive sensing cells 334A, 334B, 334C and 334D.

Turning back to FIG. 2, the processor 216 of the capacitive finger navigation 102 is connected to the drive circuit 212 and the sensing circuit 214 to create mutual capacitances at the different capacitive sensing cells 334A, 334B, 334C and 334D of the capacitive sensor array 210 and to measure the mutual capacitances to determine the position or motion of the finger 220. The processor is electrically connected to the drive circuit and the sensing circuit to provide control signals. The processor provides control signals to the drive circuit to direct the drive circuit to sequentially apply a drive signal to the drive electrodes of the capacitive sensor array to create mutual capacitances between the drive and sense electrodes of the capacitive sensor array at the capacitive sensing cells. The processor also provides control signals to the sensing circuit to sense the mutual capacitances at the capacitive sensing cells.

The processor 216 may be a general-purpose digital processor, such as a microprocessor or microcontroller. In other embodiments, the processor may be a special-purpose processor, such as a digital signal processor. In still other embodiments, the processor may be another type of controller, a field programmable gate array (FPGA), or an Application Specific Integrated Circuit (ASIC).

In the illustrated embodiment, the processor 216 includes the navigation engine 218, which is programmed into the processor. However, in other embodiments, the navigation engine may be a separate component. Thus, the navigation engine can be implemented in any combination of software, hardware and/or firmware.

The navigation engine 218 is connected to the sensing circuit 214 to receive the output value signals that correspond to the mutual capacitances at the different capacitive sensing cells 334A, 334B, 334C and 334D of the capacitive sensor array 210. The navigation engine is configured to process the output value signals from the sensing circuit to determine the position of the finger 220 relative to the capacitive sensing cells of the capacitive sensor array. In an embodiment, the navigation engine is configured to process the output value signals from the sensing circuit to determine the position of the finger relative to the center of the capacitive sensing cells of the capacitive sensor array. However, in other embodiments, the navigation engine may be configured to process the output value signals from the sensing circuit to determine the position of the finger relative to a different fixed reference point with respect to the capacitive sensing cells of the capacitive sensor array.

In an embodiment, the navigation engine 218 is configured to compute the position of the finger 220 (when present) from the received output value signals using the following four quadrant balance formulas:

x=(R−L)/(L+R) and y=(T−B)/(T+B),

where R is equal to the sum of raw delta values from two rightmost capacitive sensing cells 334B and 334D, L is equal to the sum of raw delta values from two leftmost capacitive sensing cells 334A and 334C, T is equal to the sum of raw delta values from two topmost capacitive sensing cells 334A and 334B and B is equal to the sum of raw delta values from two bottommost capacitive sensing cells 334C and 334D, wherein each raw delta value is the difference between the raw mutual capacitance value (i.e., the output value signal from the sensing circuit for the corresponding capacitive sensing cell) and a reference capacitance value (e.g., a mutual capacitance value from the same capacitive cell when no finger is present). However, in other embodiments, the navigation engine may use other formulas to compute the position of a finger from the received output value signals. With appropriate thresholds, the navigation engine is able to determine the position or movement of a finger through many types of gloves and mittens for cold weather applications.

In one mode of operation, the navigation engine 218 may be configured to output signals that represent absolute x and y position values based on the current finger position. In this mode, various positions of the finger with respect to the capacitive sensor array 210 can be mapped to corresponding positions on the display device 104. In another mode of operation, the navigation engine may be configured to combine multiple finger position results to output directional delta x displacement values and directional delta y displacement values, similar to the mode of operation for a computer mouse. In this mode, each directional displacement value includes negative or positive sign information, which indicates direction, and an absolute displacement value, which indicates the amount of displacement in that direction. Thus, the x displacement value indicates displacement change along the X axis, while the y displacement value indicates displacement change along the Y axis.

Using the capacitive sensor array 210 that has only the four capacitive sensing cells 334A, 334B, 334C and 334D, the capacitive finger navigation input device 102 is able to determine the position or movement of the finger 220 relative to the capacitive sensor array with unexpected accuracy. The configuration of the capacitive sensor array 210 is similar to sensor arrays found convention capacitive touchscreens that also use mutual capacitance technology. However, these conventional sensor arrays use a large number of sensing cells to determine the location of a finger relative to the sensor arrays without any scaling with respect to the displayed area. These types of sensor arrays for touchscreens have not been used in trackpad or touchpad applications, which have traditionally used self capacitance technology rather than mutual capacitance technology. Furthermore, it was unpredictable and unexpected that the finger position or motion can be property detected using only four capacitive sensing cells, as is the case for the capacitive sensor array 210 of the capacitive finger navigation input device 102. As it turns out, the capacitive sensor array 210 with only four capacitive sensing cells can have a resolution of over 500 discrete positions along the X and Y directions, which allows the capacitive finger navigation input device 102 to be used for absolute positioning, i.e., a particular finger position always corresponds to a particular location on the display device 104, or measuring movement or velocity of a finger. Additionally, the capacitive finger navigation input device may be configured so that the finger position can be mapped to a cursor velocity to provide a function mimicking a joystick.

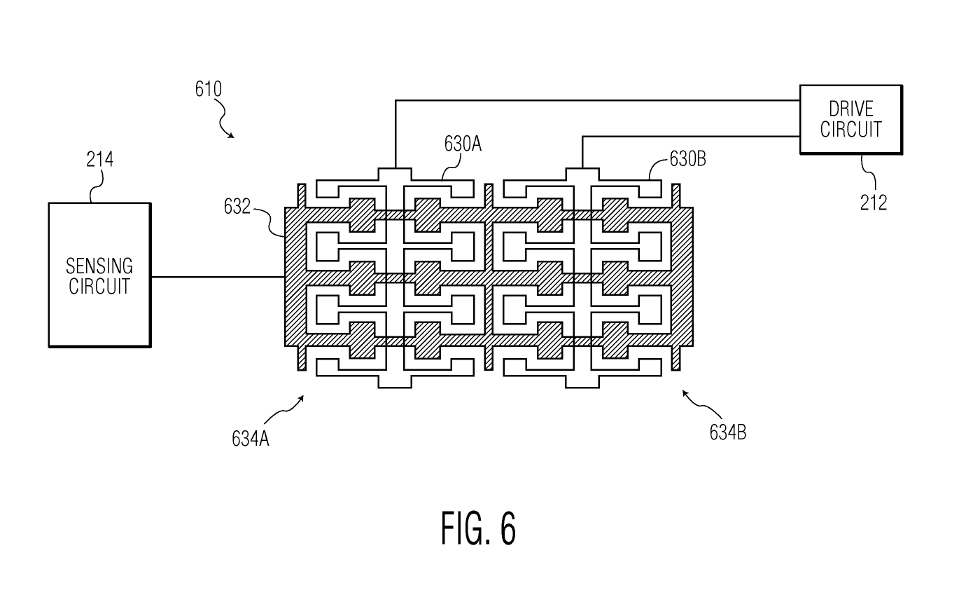

Turning now to FIG. 6, a capacitive sensor array 610 for the capacitive finger navigation input device 102 in accordance with an alternative embodiment of the invention is shown. In this embodiment, the capacitive sensor array 610 includes only two capacitive sensing cells 634A and 634B. As illustrated in FIG. 6, the two capacitive sensing cells of the capacitive sensor array can be formed using two drive electrodes 630A and 630B and as single sense electrode 632. In other configurations, the two capacitive sensing cells of the capacitive sensor array can be formed using one drive electrode and two sense electrodes or two drive electrodes and two sense electrodes. Thus, in these configurations, the capacitive sensor array may use one or two drive lines and one or two sensing units, which can each be the sensing unit 440 shown in FIG. 4. In this embodiment, the capacitive sensor array is used to control linear positioning or linear movement of a navigation indicator within a graphical user interface that is displayed on the display device 104, e.g., a cursor.

Turning now to FIG. 7, a block diagram of a round capacitive sensor array 710 that can be used in the capacitive finger navigation input device 102 in accordance with an embodiment of the invention is shown. In the illustrated embodiment, the round capacitive sensor array includes three capacitive sensing cells 734A, 734B and 734C that are each defined by a drive electrode and a sense electrode (not shown), similar to the drive and sense electrodes 330A, 330B, 332A and 332B of the capacitive sensor array shown in FIG. 3. However, in other embodiments, the round capacitive sensor array may be configured to include any number of capacitive sensing cells. As shown in FIG. 7, each of the three capacitive sensing cells is configured in a pie segment shape. In the illustrated embodiment, the three capacitive sensing cells are identical with respect to size. However, in other embodiments, the three capacitive sensing cells may have different sizes.

Similar to the capacitive sensor array 210, the round capacitive sensor array 710 may include a combination of one, two or three drive electrodes and one, two or three sense electrodes that define the capacitive sensing cells 734A, 734B and 734C. These capacitive sensing cells may be driven by the drive circuit 212 and sensed by the sensing circuit 214 in a similar manner as the capacitive sensing cells 334A, 334B, 334C and 334D of the capacitive sensor array 210 to produce output values signals, which are indicative of the mutual capacitances at the different capacitive sensing cells 734A, 734B and 734C. The output value signals are then processed by the navigation engine to compute the position of a finger (when present). In an embodiment, the navigation engine is configured to approximate the position of a finger from the received output value signals using the following balance formulas:

i x=(R−L)/(R+L) and y=(16*U−7*(L+R))/(16*U+7*(L+R)),

where R is equal to the raw delta value from the capacitive sensing cell 734C, L is equal to the delta value from the capacitive sensing cell 734B, and U is equal to the raw delta value from the capacitive sensing cell 734A, wherein each raw delta value is the difference between the raw mutual capacitance value (i.e., the output value signal from the sensing circuit for the corresponding capacitive sensing cell) and a reference capacitance value (e.g., a mutual capacitance value from the same capacitive cell when no finger is present). However, in other embodiments, the navigation engine may use other formulas to compute the position of a finger from the received output value signals.

A method for performing capacitive finger navigation in accordance with an embodiment of the invention is described with reference to a flow diagram of FIG. 8. At block 802, a driving signal is provided to at least one drive electrode of a capacitive sensor array of capacitive sensing cells. The sensor array includes only two capacitive sensing cells positioned along a first linear direction. At block 804, mutual capacitances at the capacitive sensing cells of the capacitive sensor array are sensed through at least one sense electrode of the capacitive sensor array to produce mutual capacitance signals. At block 806, the mutual capacitance signals for the capacitive sensing cells of the capacitive sensor array are processed to determine at least one of position and movement of a finger of a user with respect to the capacitive sensor array.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A capacitive finger navigation input device comprising:
a capacitive sensor array of capacitive sensing cells, the capacitive sensor array including only two capacitive sensing cells positioned along a linear direction, the capacitive sensor array including:
a substrate;
at least one drive electrode positioned over the substrate;
at least one sense electrode positioned over the substrate and electrically separated from the at least one drive electrode, where at least a portion of the at least one drive electrode and at least a portion of the at least one sense electrode define each of the capacitive sensing cells; and
an insulating cover layer positioned over the drive and sense electrodes, the insulating cover layer being positioned to interface with a finger of a user;
a drive circuit electrically connected to the at least one drive electrode to supply a drive signal to the at least drive electrode;
a sensing circuit electrically connected to the at least one sense electrode to sense mutual capacitance at each of the capacitive sensing cells to produce mutual capacitance signals; and
a navigation engine connected to the sensing circuit to receive the mutual capacitance signals, the navigation engine being configured to process the mutual capacitance signals for the capacitive sensing cells of the capacitive sensor array to determine at least one of position and movement of a finger of a user with respect to the capacitive sensor array.

2. The capacitive finger navigation input device of claim 1, wherein the capacitive sensor array is a two-by-two array of capacitive sensing cells.

3. The capacitive finger navigation input device of claim 2, wherein the capacitive sensor array is quadrilateral in shape with width of 4 mm to 20 mm and height of 4 mm to 20 mm.

4. The capacitive finger navigation input device of claim 2, wherein the navigation engine is configured to process the mutual capacitance signals for the capacitive sensing cells of the capacitive sensor array using the following formulas:
x=(R−L)/(L+R) and y=(T−B)/(T+B),
where R is equal to the sum of raw delta values from two rightmost capacitive sensing cells, L is equal to the sum of raw delta values from two leftmost capacitive sensing cells, T is equal to the sum of raw delta values from two topmost capacitive sensing cells and B is equal to the sum of raw delta values from two bottommost capacitive sensing cells, wherein each raw delta value is the difference between a raw mutual capacitance value represented by one of the mutual capacitance signals and a reference capacitance value.

5. The capacitive finger navigation input device of claim 2, wherein the capacitive sensor array includes only two drive electrodes and only two sense electrodes, each of the capacitive sensing cells being formed by a portion of one of the two drive electrodes and a portion of one of the two sense electrodes.

6. The capacitive finger navigation input device of claim 5, wherein the drive circuit is configured to sequentially apply the drive signal to each of the two drive electrodes and wherein the sensing circuit is configured to individually sense the mutual capacitance at each of the capacitive sensing cells through the two sense electrodes to produce the mutual capacitance signals.

7. The capacitive finger navigation input device of claim 6, wherein the sense circuit includes two sensing units, each of the two sensing units includes a charge amplifier connected to one of the two sense electrodes, an analog amplifier connected to the charge amplifier and a low pass filter connected to the charge amplifier.

8. The capacitive finger navigation input device of claim 1, wherein the capacitive sensor array is round in shape and wherein each of the capacitive sensing cells is configured in a pie segment shape.

9. The capacitive finger navigation input device of claim 8, wherein the capacitive sensor array includes only three capacitive sensing cells and wherein the navigation engine is configured to process the mutual capacitance signals for the three capacitive sensing cells of the capacitive sensor array using the following formulas:
x=(R−L)/(R+L) and y=(16*U−7*(L+R))/(16*U+7*(L+R)),
where R is equal to a raw delta value from a first capacitive sensing cell, L is equal to a delta value from a second capacitive sensing cell, and U is equal to a raw delta value from a third capacitive sensing cell, wherein each raw delta value is the difference between a raw mutual capacitance value represented by one of the mutual capacitance signals and a reference capacitance value.

10. A hand-held computing system comprising:
a display device comprising a navigation indicator for a graphical user interface;
a capacitive sensor array of capacitive sensing cells, the capacitive sensor array including only two capacitive sensing cells positioned along a linear direction, the capacitive sensor array including:
a substrate;
at least one drive electrode positioned over the substrate;
at least one sense electrode positioned over the substrate and electrically separated from the at least one drive electrode, where at least a portion of the at least one drive electrode and at least a portion of the at least one sense electrode define each of the capacitive sensing cells; and
an insulating cover layer positioned over the drive and sense electrodes, the insulating cover layer being positioned to interface with a finger of a user;
a drive circuit electrically connected to the at least one drive electrode to supply a drive signal to the at least drive electrode;
a sensing circuit electrically connected to the at least one sense electrode to sense mutual capacitance at each of the capacitive sensing cells to produce mutual capacitance signals; and
a navigation engine connected to the sensing circuit to receive the mutual capacitance signals, the navigation engine being configured to process the mutual capacitance signals for the capacitive sensing cells of the capacitive sensor array to determine at least one of position and movement of a finger of a user with respect to the capacitive sensor array to control the navigation indicator.

11. The hand-held computing system of claim 10, wherein the display device includes a touchscreen.

12. The hand-held computing system of claim 10, wherein the capacitive sensor array is a two-by-two array of capacitive sensing cells.

13. The hand-held computing system of claim 12, wherein the capacitive sensor array is quadrilateral in shape with width of 4 mm to 20 mm and height of 4 mm to 20 mm.

14. The hand-held computing system of claim 12, wherein the navigation engine is configured to process the mutual capacitance signals for the capacitive sensing cells of the capacitive sensor array using the following formulas:
x=(R−L)/(L+R) and y=(T−B)/(T+B),
where R is equal to the sum of raw delta values from two rightmost capacitive sensing cells, L is equal to the sum of raw delta values from two leftmost capacitive sensing cells, T is equal to the sum of raw delta values from two topmost capacitive sensing cells and B is equal to the sum of raw delta values from two bottommost capacitive sensing cells, wherein each raw delta value is the difference between a raw mutual capacitance value represented by one of the mutual capacitance signals and a reference capacitance value.

15. The hand-held computing system of claim 10, wherein the sense circuit includes at least one sensing unit, each sensing unit including a charge amplifier connected to the at least one sense electrode, an analog amplifier connected to the charge amplifier and a low pass filter connected to the charge amplifier.

16. The hand-held computing system of claim 10, wherein the capacitive sensor array is round in shape and wherein each of the capacitive sensing cells is configured in a pie segment shape.

17. The hand-held computing system of claim 16, wherein the capacitive sensor array includes only three capacitive sensing cells and wherein the navigation engine is configured to process the mutual capacitance signals for the three capacitive sensing cells of the capacitive sensor array using the following formulas:
x=(R−L)/(R+L) and y=(16*U−7*(L+R))/(16*U+7*(L+R)),
where R is equal to a raw delta value from a first capacitive sensing cell, L is equal to a delta value from a second capacitive sensing cell, and U is equal to a raw delta value from a third capacitive sensing cell, wherein each raw delta value is the difference between a raw mutual capacitance value represented by one of the mutual capacitance signals and a reference capacitance value.

18. A method for performing capacitive finger navigation, the method comprising:
providing a driving signal to at least one drive electrode of a capacitive sensor array of capacitive sensing cells, the capacitive sensor array including only two capacitive sensing cells positioned along a linear direction;
sensing mutual capacitances at the capacitive sensing cells of the capacitive sensor array through at least one sense electrode of the capacitive sensor array to produce mutual capacitance signals; and
processing the mutual capacitance signals for the capacitive sensing cells of the capacitive sensor array to determine at least one of position and movement of a finger of a user with respect to the capacitive sensor array.

19. The method of claim 18, wherein the capacitive sensor array is a two-by-two array of capacitive sensing cells and wherein the processing includes processing the mutual capacitance signals for the capacitive sensing cells of the capacitive sensor array using the following formulas:
x=(R−L)/(L+R) and y=(T−B)/(T+B),
where R is equal to the sum of raw delta values from two rightmost capacitive sensing cells, L is equal to the sum of raw delta values from two leftmost capacitive sensing cells, T is equal to the sum of raw delta values from two topmost capacitive sensing cells and B is equal to the sum of raw delta values from two bottommost capacitive sensing cells, wherein each raw delta value is the difference between a raw mutual capacitance value represented by one of the mutual capacitance signals and a reference capacitance value.

20. The method of claim 18, wherein the capacitive sensor array is round in shape and each of the capacitive sensing cells is configured in a pie segment shape, wherein the capacitive sensor array includes only three capacitive sensing cells, and wherein the processing includes processing the mutual capacitance signals for the capacitive sensing cells of the capacitive sensor array using the following formulas:
x=(R−L)/(R+L) and y=(16*U−7*(L+R))/(16*U+7*(L+R)),
where R is equal to a raw delta value from a first capacitive sensing cell, L is equal to a delta value from a second capacitive sensing cell, and U is equal to a raw delta value from a third capacitive sensing cell, wherein each raw delta value is the difference between a raw mutual capacitance value represented by one of the mutual capacitance signals and a reference capacitance value.
